(19) United States
(12) Patent Application Publication
(10) Pub. No.: US 2025/0087407 A1
(43) Pub. Date: Mar. 13, 2025

(54) COIL COMPONENT

(71) Applicant: SAMSUNG ELECTRO-MECHANICS CO., LTD., Suwon-si (KR)

(72) Inventors: Sang Jin KIM, Suwon-si (KR); Boum Seock KIM, Suwon-si (KR); Byeong Cheol MOON, Suwon-si (KR); Han LEE, Suwon-si (KR); Seong Jun PARK, Suwon-si (KR)

(73) Assignee: SAMSUNG ELECTRO-MECHANICS CO., LTD., Suwon-si (KR)

(21) Appl. No.: 18/799,548

(22) Filed: Aug. 9, 2024

(30) Foreign Application Priority Data
Sep. 12, 2023 (KR) 10-2023-0121275

(51) Int. Cl. H01F 27/28; H01F 27/02; H01F 27/29; H01F 27/30

(52) U.S. Cl. CPC H01F 27/2828; H01F 27/022; H01F 27/29; H01F 27/306

(57) ABSTRACT

A coil component includes a body having a first surface, a second surface opposing the first surface in a first direction, and side surfaces connecting the first surface and the second surface to each other, a support member disposed in the body, a coil disposed on each of one surface of the support member and the other surface of the support member opposing the one surface in the first direction, including first and second lead-out portions respectively extending to a first side surface and a second side surface of the body opposing each other in a second direction, and a first dummy lead-out portion disposed on the other surface of the support member, and connected to the first lead-out portion. W2/W1 satisfies 0.3 or more and 0.8 or less, W1 is a width of the first lead-out portion, W2 is a width of the first dummy lead-out portion.

### CROSS-REFERENCE TO RELATED APPLICATION(S)

This application claims benefit of priority to Korean Patent Application No. 10-2023-0121275 filed on Sep. 12, 2023 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor, and is used in resonant circuits and filter circuits amplifying signals in a specific frequency band in combination with a capacitor using electromagnetic properties.

One of the important properties of a power inductor is energy efficiency thereof. Even when a DC bias is applied, the smaller the change in direct current resistance (Rdc), the lower the losses caused by heat, resulting in an increase in efficiency. A general thin-film power inductor has a dispersion value when resistance for each external electrode terminal position is measured, and a reduction in deviation may be directly related to ensuring energy efficiency of the power inductor.

### SUMMARY

An aspect of the present disclosure is to improve deviation of direct current resistance (Rdc) for each external electrode terminal position.

According to an aspect of the present disclosure, there is provided a coil component including a body having a first surface, a second surface opposing the first surface in a first direction, and a plurality of side surfaces connecting the first surface and the second surface to each other, the plurality of side surfaces including a first side surface and a second side surface opposing each other in a second direction, a support member disposed in the body, a coil disposed on each of a first surface of the support member and a second surface of the support member opposing the first surface of the support member in the first direction, the coil including first and second lead-out portions respectively extending to the first side surface and the second side surface, and a first dummy lead-out portion disposed on the second surface of the support member and connected to the first lead-out portion. When a width of the first lead-out portion is W1 and a width of the first dummy lead-out portion is W2, W2/W1 may satisfy 0.3 or more and 0.8 or less.

According to another aspect of the present disclosure, there is provided a coil component including a body having a first surface, a second surface opposing the first surface in a first direction, and a plurality of side surfaces connecting the first surface and the second surface to each other, the plurality of side surfaces including a first side surface and a second side surface opposing each other in a second direction, a support member disposed in the body, a coil disposed on each of a first surface of the support member and a second surface of the support member opposing the first surface of the support member in the first direction, the coil including first and second lead-out portions respectively extending to the first side surface and the second side surface, a first dummy lead-out portion disposed on the second surface of the support member and connected to the first lead-out portion, and a second dummy lead-out portion disposed on the first surface of the support member and connected to the second lead-out portion. When a width of each of the first and second lead-out portions is W1 and a width of each of the first and second dummy lead-out portions is W2, W2/W1 may satisfy 0.2 or more and 0.5 or less.

An aspect of the present disclosure provides a coil component having improved deviation in direct current resistance (Rdc) for each external electrode terminal position.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to a first example embodiment of the present disclosure;

FIG. 2 is an exploded view of a coil component according to a first example embodiment of the present disclosure;

FIG. 3 is a schematic cross-sectional view taken along line I-I′ of FIG. 1;

FIG. 4 is a cross-sectional view of a modification of a coil component according to a first example embodiment of the present disclosure, and the cross-sectional view corresponds to FIG. 3;

FIG. 5 is a schematic perspective view of a coil component according to a second example embodiment of the present disclosure;

FIG. 6 is an exploded view of a coil component according to a second example embodiment of the present disclosure;

FIG. 7 is a schematic cross-sectional view taken along line II-II′ of FIG. 5;

FIG. 8 is a cross-sectional view of a modification of a coil component according to a second example embodiment of the present disclosure, and the cross-sectional view corresponds to FIG. 7; and

FIG. 9 is a cross-sectional view of a coil component according to a comparative example embodiment.

### DETAILED DESCRIPTION

Hereinafter, example embodiments of the present disclosure are described with reference to specific example embodiments and accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In the drawings, an X-direction may be defined as a first direction or thickness direction, a Y-direction may be defined as a second direction or longitudinal direction, and a Z-direction may be defined as a third direction or width direction.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification.

Throughout the specification, when an element is referred to as “comprising” or “including,” it means that it may include other elements as well, rather than excluding other elements, unless specifically stated otherwise.

Hereinafter, a coil component according to an example of the present disclosure will be described, but the present disclosure is not necessarily limited thereto.

### First Example Embodiment

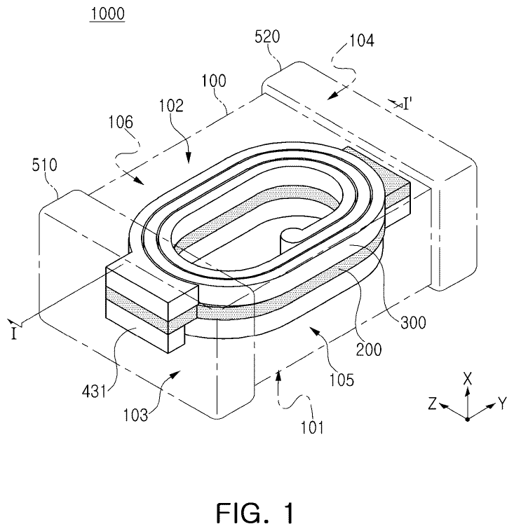

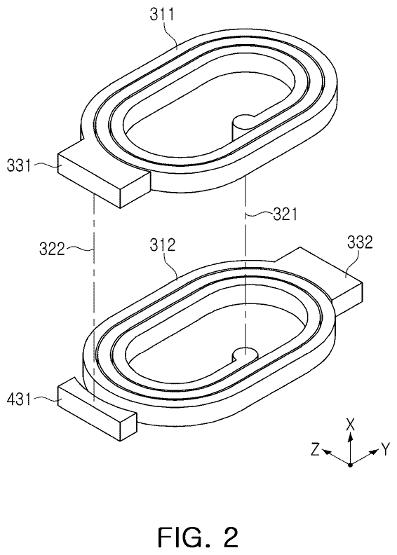

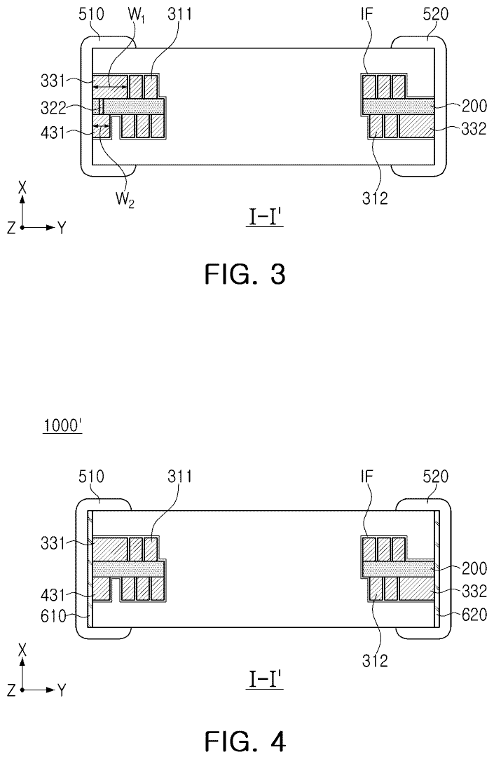

FIG. 1 is a schematic perspective view of a coil component according to a first example embodiment of the present disclosure. FIG. 2 is an exploded view of a coil component according to a first example embodiment of the present disclosure. FIG. 3 is a schematic cross-sectional view taken along line I-I′ of FIG. 1.

Referring to FIGS. 1 to 3, a coil component 1000 according to a first example embodiment of the present disclosure may include a body 100, a support member 200, a coil 300, and a first dummy lead-out portion 431, and may further include external electrodes 510 and 520 and an insulating film IF.

The body 100 may form the exterior of the coil component 1000 according to the present example embodiment, and may include the support member 200 and the coil 300 buried therein.

The body 100 may have an overall hexahedral shape.

Hereinafter, the first example embodiment of the present disclosure will be described in the case that the body 100 has a hexahedral shape. However, the above description does not exclude a coil component including a body having a shape other than a hexahedral shape from the scope of the present example embodiment.

Referring to FIG. 1, the body 100 may have a first surface 101 and a second surface 102 opposing each other in a first direction (X-direction), a first side surface 103 and a second side surface 104 opposing each other in a second direction (Y-direction), and a third side surface 105 and a fourth side surface 106 opposing each other in a third direction (Z-direction). The first to fourth side surfaces 103, 104, 105, and 106 of the body 100 may be respectively a plurality of side surfaces of the body 100, connecting the first surface 101 and the second surface 102 of the body 100 to each other.

For example, the body 100 may be formed such that the coil component 1000 according to the present example embodiment, including the external electrodes 510 and 520 to be described below, has a length of 2.5 mm, a width of 2.0 mm, and a thickness of 2.0 mm, but the present disclosure is not limited thereto. The above-described numerical values are merely design values not reflecting a process error or the like, such that it should be considered that dimensions within a range admitted as a processor error fall within the scope of the present disclosure.

The body 100 may include a magnetic material and an insulating resin. Specifically, the body 100 may be formed by laminating one or more magnetic composite sheets in which the magnetic material is dispersed in the insulating resin. However, the body 100 may have a structure other than a structure in which the magnetic material is dispersed in the insulating resin. For example, the body 100 may be formed of a magnetic material such as ferrite, or may be formed of a non-magnetic material.

The magnetic material may be ferrite powder particles or metal magnetic powder particles.

The ferrite powder particles may be, for example, at least one of spinel-type ferrite power particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite power particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite powder particles such as Y-based ferrite powder particles or the like, and Li-based ferrite powder particles.

The magnetic metal powder particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The magnetic metal powder particles may be amorphous or crystalline. For example, the magnetic metal powder particles may be Fe—Si—B—Cr-based amorphous alloy powder particles, but the present disclosure is not necessarily limited thereto.

Each of the ferrite powder particles and the magnetic metal powder particles may have an average diameter of about 0.1 μm to about 30 μm, but the present disclosure is not limited thereto.

The body 100 may include two or more types of magnetic materials dispersed in the insulating resin. Here, different types of magnetic materials mean that the magnetic materials dispersed in the resin are distinguished from each other by one of an average diameter, a composition, crystallinity, and a shape.

The insulating resin may include epoxy, polyimide, a liquid crystal polymer, or the like alone or in combination, but the present disclosure is not limited thereto.

The body 100 may include a core 110 passing through a central portion of each of the support member 200 and the coil 300 to be described below. The core 110 may be formed by filling a through-hole of the central portion of each of the support member 200 and the coil 300 with a magnetic composite sheet, but the present disclosure is not limited thereto.

The support member 200 may be buried in the body 100. The support member 200 may be configured to support the coil 300 to be described below.

The support member 200 may be formed of an insulating material including a thermosetting insulating resin such as an epoxy resin, a thermoplastic insulating resin such as polyimide, or a photosensitive insulating resin, or an insulating material in which a reinforcing material, such as a glass fiber or an inorganic filler, is impregnated with an insulating resin. For example, the support member 200 may be formed of an insulating material such as prepreg, an Ajinomoto build-up film (ABF), FR-4, a bismaleimide triazine (BT) resin, a photoimageable dielectric (PID), or the like, but the present disclosure is not limited thereto.

The inorganic filler may be at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide more excellent rigidity. When the support member 200 is formed of an insulating material including no glass fiber, it may be advantageous in reducing an overall thickness of the coil component 1000 according to the present example embodiment. When the support member 200 is formed of an insulating material including a photosensitive insulating resin, the number of processes of forming the coil 300 may be reduced. Thus, it may be advantageous in reducing production costs, and a fine via may be formed.

The coil 300 may be buried in the body 100, and may be disposed on at least one surface of the support member 200 to exhibit properties of the coil component 1000. For example, when the coil component 1000 according to the present example embodiment is used as a power inductor, the coil 300 may serve to stabilize power of an electronic device by storing an electric field as a magnetic field and maintaining an output voltage.

The coil 300 may include coil patterns 311 and 312, lead-out portions 331 and 332, and vias 321, 322, and 323. Specifically, with respect to the direction of FIG. 1, a first coil pattern 311 and a first lead-out portion 331 may be disposed on one surface (upper surface) of the support member 200, and a second coil pattern 312 and a second lead-out portion 332 may be disposed on the other surface (lower surface) of the support member 200.

Each of the first coil pattern 311 and the second coil pattern 312 may have a planar spiral shape in which at least one turn is formed using the core 110 as an axis. For example, the first coil pattern 311 may form at least one turn on the upper surface of the support member 200, using the core 110 as an axis. Likewise, the second coil pattern 312 may form at least one turn on the lower surface of the support member 200, using the core 110 as an axis.

The first lead-out portion 331 may be disposed on one surface (upper surface) of the support member 200, may extend to the first side surface 103, and may be connected to a first external electrode 510 to be described below. The second lead-out portion 332 may be disposed on the other surface (lower surface) of the support member 200, may extend to the second side surface 104, and may be connected to a second external electrode 520 to be described below.

The first via 321 may pass through the support member 200 to be in contact with each of the first coil pattern 311 and the second coil pattern 312. Thus, the coil 300 may generally function as a single coil forming one or more turns with respect to the core 110. The coil component according to the present disclosure may further include second and third vias 322 and 323, which will be described in detail below.

At least one of the coil patterns 311 and 312, the vias 321, 322, and 323, and the lead-out portions 331 and 332 may include one or more conductive layers. For example, when the first coil pattern 311, the first lead-out portion 331, and the via 321 are formed using plating, the first coil pattern 311, the first lead-out portion 331, and the via 321 may include a seed layer such as an electroless plating layer and an electroplating layer, respectively. Here, the electroplating layer may have a single-layer structure or a multilayer structure. The electroplating layer, having a multilayer structure, may be formed to have a conformal film structure in which one electroplating layer is formed on another electroplating layer, and may be formed to have a shape in which one electroplating layer is laminated only on one surface of another electroplating layer. The seed layer of the first coil pattern 311, the seed layer of the first lead-out portion 331, and the seed layer of the via 321 may be formed integrally with each other, such that no boundaries may be formed therebetween, but the present disclosure is not limited thereto.

For another example, the first coil pattern 311 and the second coil pattern 312 are formed separately from each other and then collectively laminated on the support member 200 to form the coil 300, the via 321 may include a low melting point metal layer having a melting point, lower than a melting point of a high melting point metal layer. Here, the low melting point metal layer may be formed of solder including lead (Pb) and/or tin (Sn). At least a portion of the low melting point metal layer may be melted due to pressure and temperature when collectively laminated, and accordingly, an intermetallic compound layer (IMC Layer) may be formed at a boundary between the low melting point metal layer and the second coil pattern 312, for example.

With respect to the direction of FIG. 3, the coil patterns 311 and 312 and the lead-out portions 331 and 332 may be formed to protrude from the upper and lower surfaces of the support member 200, respectively. For another example, the first coil pattern 311 and the first lead-out portion 331 may be formed to protrude on the upper surface of the support member 200, and the second coil pattern 312 and the second lead-out portion 332 may be buried in the lower surface of the support member 200, such that lower surfaces of the second coil pattern 312 and the second lead-out portion 332 may be exposed to the lower surface of the support member 200. In this case, a concave portion may be formed on lower surfaces of the second coil pattern 312 and/or the second lead-out portion 332, such that the lower surfaces of the second coil pattern 312 and/or the second lead-out portion 332 and the lower surface of the support member 200 may not be positioned on the same plane. For another example, the second coil pattern 312 and the second lead-out portion 332 may be formed to protrude from the lower surface of the support member 200, and the first coil pattern 311 and the first lead-out portion 331 may be buried in the upper surface of the support member 200, such that an upper surface of each of the first coil pattern 311 and the first lead-out portion 331 may be exposed to the upper surface of the support member 200. In this case, a concave portion may be formed on the upper surfaces of the first coil pattern 311 and/or the first lead-out portion 331, such that the upper surfaces of the first coil pattern 311 and/or the first lead-out portion 331 and the upper surface of the support member 200 may not be positioned on the same plane.

Each of the coil patterns 311 and 312, the vias 321, 322, and 323, and the lead-out portions 331 and 332 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

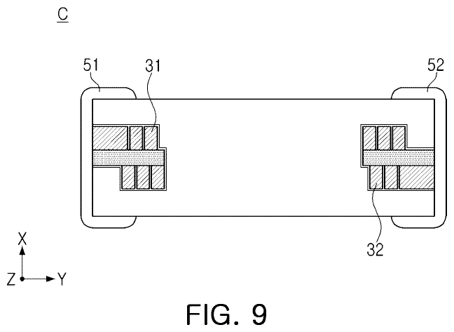

FIG. 9 is a cross-sectional view of a coil component according to a comparative example embodiment. Referring to FIG. 9, in the coil component according to the comparative example embodiment, ends of coil patterns 31 and 32 may be connected to external electrodes 51 and 52, and no dummy lead-out portion may be formed.

When direct current resistance (Rdc) of the coil component is measured, a measured resistance value may vary depending on a position of a terminal on which measurement is performed. In particular, a thin-film inductor, having a low resistance of 10 mΩ or less, may have a measured deviation of 20%.

That is, a general thin-film power inductor may have a dispersion value when resistance for each external electrode terminal position is measured, and a reduction in deviation may be directly related to ensuring energy efficiency of the power inductor.

Accordingly, the present disclosure proposes a coil component structure in which deviation in direct current resistance (Rdc) for each external electrode terminal position is improved by introducing a dummy lead-out portion 431, as described below.

The coil component 1000 according to the present example embodiment may include a first dummy lead-out portion 431 connected to the first lead-out portion 331, the first dummy lead-out portion 431 disposed on the other surface of the support member 200.

The first dummy lead-out portion 431 may be disposed on the other surface of the support member 200. Specifically, the first dummy lead-out portion 431 may be disposed on the other surface (lower surface) of the support member 200, and may not be in physical contact with the second coil pattern 312, disposed on the other surface (lower surface) of the support member 200.

The first dummy lead-out portion 431 may extend to the first side surface 103 of the body to be connected to the first external electrode 510.

The first dummy lead-out portion 431 may be connected to the first lead-out portion 331 and a second via 322. The second via 322 may pass through the support member 200 to connect the first lead-out portion 331 and the first dummy lead-out portion 431 to each other. However, the present disclosure is not necessarily limited thereto. As in a modification example to be described below, the first lead-out portion 331 and the first dummy lead-out portion 431 may be connected to a first metal layer 610, rather than the second via 322.

[Table 1] below indicates results of measuring properties of coil components according to the first, second, and comparative example embodiments of the present disclosure.

In a case (the first example embodiment) in which a dummy lead-out portion is formed on one surface of a support member, a case (the second example embodiment) in which a dummy lead-out portion is formed on opposite side surfaces of a support member, and the comparative example embodiment, inductance (Ls), direct current resistance (Rdc) and saturation current (Isat) were measured, and a coefficient of variation and measured deviation (V) of Rdc were calculated. In respective example embodiments, the dummy lead-out portions were formed to have the same width of 349 μm and the same thickness of 300 μm.

TABLE 1

| | | | | | Measured |
|---|---|---|---|---|---|
| | | | | Coefficient | Deviation |
| | Ls[nH] | Rdc[mΩ] | Isat[A] | of Variation | [%] |
| Comparative | 103.43 | 2.506 | 16.41 | 8.5 | 20 |
| Example | | | | | |
| Embodiment | | | | | |
| First | 102.11 | 2.485 | 16.43 | 5.6 | 5.7 |
| Example | | | | | |
| Embodiment | | | | | |
| Second | 100.74 | 2.463 | 16.45 | 5.0 | 2.2 |
| Example | | | | | |
| Embodiment | | | | | |

Referring to [Table 1], it can be confirmed that the first and second embodiments in which a dummy lead-out portion is formed had small values of a coefficient of variation and measured deviation of Rdc, as compared to the comparative example embodiment in which a dummy lead-out portion is not formed. That is, due to the formation of the dummy lead-out portion, a deviation value when resistance for each external electrode terminal position is measured was reduced.

However, it can be confirmed that a value of Ls was reduced, as compared to the comparative example embodiment. That is, Rdc and Ls may be in a trade-off relationship, and it may be necessary to ensure appropriate properties of a coil component.

Accordingly, the coil component 1000 according to the present example embodiment may adjust properties of a component by adjusting a width of a dummy lead-out portion. Specifically, when one dummy lead-out portion (first dummy lead-out portion 431) is formed, when a width of a first lead-out portion is W1 and a width of a first dummy lead-out portion is W2, W2/W1 may satisfy 0.3 or more and 0.8 or less.

Here, a width of a lead-out portion (dummy lead-out portion) may represent an average length of the lead-out portion (dummy lead-out portion) in a second direction (Y-direction). The widths of the first lead-out portion and the first dummy lead-out portion may be measured using the following method. A sample having a cross-section, exposed by grinding a coil component to ½ depth in a third direction (Z-direction), may be prepared. The prepared sample may be observed using an optical microscope or the like, and lengths of the first lead-out portion and the first dummy lead-out portion in the second direction (Y-direction) may be measured. Measurements may be performed a plurality of times (n times), and the widths may be obtained by calculating an arithmetic mean of measured values. Other methods and/or tools appreciated by one of ordinary skill in the art, even if not described in the present disclosure, may also be used.

[Table 2] below indicates changes in Ls and Rdc according to a value of W2/W1, when a width of a first lead-out portion is W1 and a width of a first dummy lead-out portion is W2 in a case in which one dummy lead-out portion (first dummy lead-out portion 431) is formed.

TABLE 2

| | | | Ls change | Rdc change |
|---|---|---|---|---|
| W2/W1 | Ls[nH] | Rdc[mΩ] | rate [%] | rate (%) |
| 0 | 100.0 | 2.500 | 0.00% | 0.00 |
| (Comparative | | | | |
| Example | | | | |
| Embodiment) | | | | |
| 0.1 | 98.8 | 2.491 | −1.20% | −0.36 |
| 0.2 | 97.1 | 2.476 | −2.90% | −0.96 |
| 0.3 | 96.3 | 2.445 | −3.70% | −2.20 |
| 0.4 | 95.6 | 2.418 | −4.40% | −3.28 |
| 0.5 | 94.5 | 2.389 | −5.50% | −4.44 |
| 0.6 | 93.6 | 2.365 | −6.40% | −5.40 |
| 0.7 | 92.8 | 2.345 | −7.20% | −6.20 |
| 0.8 | 90.2 | 2.301 | −9.80% | −7.96 |
| 0.9 | 88.5 | 2.280 | −11.50% | −8.80 |
| 1.0 | 86.1 | 2.248 | −13.90% | −10.08 |

Referring to [Table 2] above, when W2/W1 is 0.3 or more and 0.8 or less, a change rate of Ls may be within 10%, and a resistance dispersion value may be improved without a significant degradation in Ls properties.

An insulating film IF may be formed on surfaces of the coil 300 and the dummy lead-out portion 431. The insulating film IF may integrally cover the coil 300, the dummy lead-out portion 431, and the support member 200. Specifically, the insulating film IF may be disposed between the coil 300 and the body 100, between the dummy lead-out portion 431 and the body 100, and between the support member 200 and the body 100. The insulating film IF may be formed along a surface of the support member 200 on which the coil 300 is formed, but the present disclosure is not limited thereto. The insulating film IF may fill a region such as a space between respective adjacent turns of the coil 300. The insulating film IF may be used to electrically isolate the coil 300 and the body 100 from each other, and may include a known insulating material such as parylene, but the present disclosure is not limited thereto. For another example, the insulating film IF may include an insulating material such as an epoxy resin, rather than parylene. The insulating film IF may be formed using vapor deposition, but the present disclosure is not limited thereto. For another example, the insulating film IF may be formed by coating and curing an insulating film for forming an insulating film on opposite surfaces of the support member 200 on which the coil 300 is formed, and may be formed by coating and curing an insulating paste for forming an insulating film on the opposite surfaces of the support member 200 on which the coil 300 is formed. For the above-described reasons, the insulating film IF may be omitted in the present example embodiment. That is, when the body 100 has sufficient electrical resistance at a designed operating current and voltage of the coil component 1000, the insulating film IF may be omitted in the present example embodiment.

The external electrodes 510 and 520 may be disposed on a surface of the body 100 to be connected to the first and second lead-out portions 331 and 332, respectively. The first and second lead-out portions 331 and 332 may extend to the first and second side surfaces 103 and 104, respectively. Accordingly, the first external electrode 510 may be disposed on the first side surface 103 to be contact-connected to the first lead-out portion 331 extending to the first side surface 103 of the body 100, and the second external electrode 520 may be disposed on the second side surface 104 to be contact-connected to the second lead-out portion 332 extending to the second side surface 104 of the body 100.

In addition, in the present example embodiment, the first dummy lead-out portion 431 may also extend to the first side surface 103 of the body to be contact-connected to the first external electrode 510.

The first and second external electrodes 510 and 520 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto. The first and second external electrodes 510 and 520 may have a multilayer structure. For example, a first layer on which the first and second external electrodes 510 and 520 are connected to the coil 300 may be a conductive resin layer including conductive power particles, including at least one of copper (Cu) and silver (Ag), and an insulating resin, or a copper (Cu) plating layer. In addition, a second layer may have a double-layer structure including a nickel (Ni) plating layer and a tin (Sn) plating layer. The first layer may be formed using electroplating, vapor deposition such as sputtering, or may be formed by coating and curing a conductive paste including conductive powder particles such as copper (Cu) and/or silver (Ag), and the second layer may be formed using electroplating.

FIG. 4 is a cross-sectional view of a modification of a coil component according to a first example embodiment of the present disclosure, and the cross-sectional view corresponds to FIG. 3.

A modification 1000′ of the coil component according to the first example embodiment may further include a first metal layer 610 disposed on the first side surface 103 of the body.

The first metal layer 610 may be disposed on the first side surface 103 of the body to be in contact with the first lead-out portion 331 and the first dummy lead-out portion 431. In the above-described first example embodiment, the first lead-out portion 331 and the first dummy lead-out portion 431 may be connected to each other through the second via 322. Conversely, in the present modification, the first lead-out portion 331 and the first dummy lead-out portion 431 may be connected to each other through the first metal layer 610. Accordingly, in the present modification, the second via 322 may be omitted.

The first metal layer 610 may serve to connect the first lead-out portion 331 and the first dummy lead-out portion 431 to each other, and may serve to improve a contact force of the external electrode 510. Specifically, the first metal layer 610 may expand the first lead-out portion 331 to expand a contact area with the external electrode 510.

The first metal layer 610 may include at least one of Cu (copper), Pd (palladium), and Cr (chromium), and may be formed using electroplating, but the present disclosure is not limited thereto.

### Second Example Embodiment

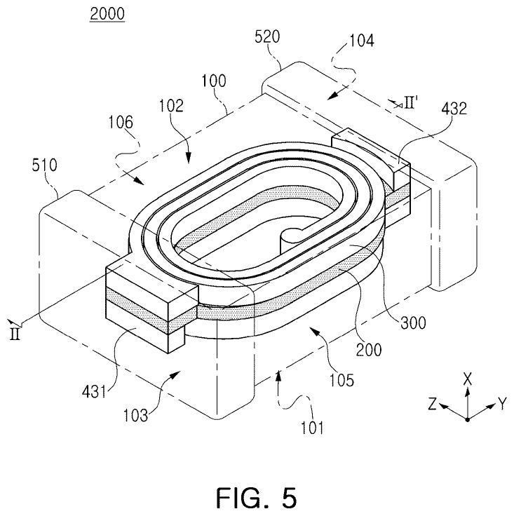

FIG. 5 is a schematic perspective view of a coil component according to a second example embodiment of the present disclosure.

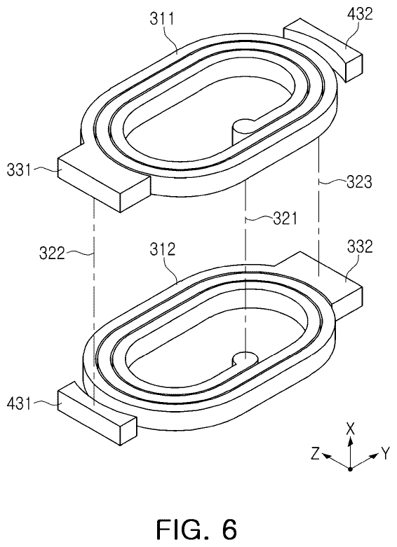

FIG. 6 is an exploded view of a coil component according to a second example embodiment of the present disclosure.

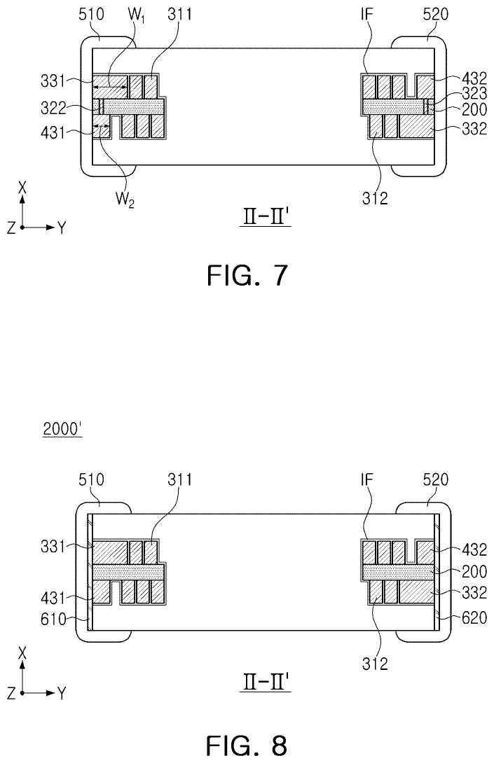

FIG. 7 is a schematic cross-sectional view taken along line II-II′ of FIG. 5.

Referring to FIGS. 5 to 7, a coil component 2000 according to a second example embodiment of the present disclosure may include a second dummy lead-out portion 432 connected to a second lead-out portion, the second dummy lead-out portion 432 disposed on one surface of a support member 200.

Specifically, the second dummy lead-out portion 432 may be disposed on the one surface of the support member 200. Specifically, the second dummy lead-out portion 432 may be disposed on one surface (upper surface) of the support member 200, and may not be in physical contact with a first coil pattern 311 disposed on the one surface (upper surface) of the support member 200.

The second dummy lead-out portion 432 may extend to a second side surface 104 of a body to be connected to a second external electrode 520.

The second dummy lead-out portion 432 may be connected to a second lead-out portion 332 through a third via 323. The third via 323 may pass through the support member 200 to connect the second lead-out portion 332 and the second dummy lead-out portion 432 to each other. However, the present disclosure is not necessarily limited thereto. As in a modification to be described below, the second lead-out portion 332 and the second dummy lead-out portion 432 may be connected to each other through a second metal layer 620, rather than the third via 323.

The coil component according to the second example embodiment may include two dummy lead-out portions 431 and 432, as compared to the first example embodiment. In addition, a lead-out portion and a dummy lead-out portion may have slightly different widths. Specifically, when a width of each of first and second lead-out portions is W1 and a width of each of first and second dummy lead-out portions is W2, W2/W1 may satisfy 0.2 or more and 0.5 or less.

The first and second lead-out portions 331 and 332 may have the same width, represented by W1, and the first and second dummy lead-out portions 431 and 432 may have the same width, represented by W2.

As a method of measuring widths of the second lead-out portion 332 and the second dummy lead-out portion 432, the above-described method of measuring the widths of the first lead-out portion 331 and the first dummy lead-out portion 431 according to the first example embodiment may be inferred.

[Table 3] below indicates changes in inductance (Ls) and direct current resistance (Rdc) according to a value of W2/W1, when a width of each of first and second lead-out portions is W1 and a width of each of first and second dummy lead-out portions is W2 in a case in which two dummy lead-out portions 431 and 432 are formed.

TABLE 3

| | | | Ls change | Rdc change |
|---|---|---|---|---|
| W2/W1 | Ls[nH] | Rdc[mΩ] | rate [%] | rate (%) |
| 0 | 100.0 | 2.500 | 0.00% | 0.00 |
| (Comparative | | | | |
| Example | | | | |
| Embodiment) | | | | |
| 0.1 | 97.6 | 2.482 | −2.40% | −0.72 |
| 0.2 | 94.2 | 2.452 | −5.80% | −1.92 |
| 0.3 | 92.6 | 2.390 | −7.40% | −4.40 |
| 0.4 | 91.2 | 2.336 | −8.80% | −6.56 |
| 0.5 | 90.1 | 2.278 | −9.90% | −8.88 |
| 0.6 | 87.2 | 2.230 | −12.80% | −10.80 |
| 0.7 | 85.6 | 2.190 | −14.40% | −12.40 |
| 0.8 | 80.4 | 2.102 | −19.60% | −15.92 |
| 0.9 | 77.0 | 2.060 | −23.00% | −17.60 |
| 1.0 | 72.2 | 1.996 | −27.80% | −20.16 |

Referring to [Table 3], when W2/W1 is 0.2 or more and 0.5 or less, a change rate of Ls may be within 10%, and a resistance dispersion value may be improved without a significant degradation in Ls properties.

That is, as compared to the first example embodiment, the dummy lead-out portions 431 and 432 may be symmetrically formed on opposite surfaces of the support member 200, thereby improving a resistance dispersion value even with a relatively small width (ratio).

FIG. 8 is a cross-sectional view of a modification of a coil component according to a second example embodiment of the present disclosure, and the cross-sectional view corresponds to FIG. 7.

A modification 2000′ of the coil component according to the second example embodiment may further include a second metal layer 620 disposed on the second side surface 104 of the body.

The second metal layer 620 may be disposed on the second side surface 104 of the body to be in contact with the second lead-out portion 332 and the second dummy lead-out portion 432. In the above-described second example embodiment, the second lead-out portion 332 and the second dummy lead-out portion 432 may be connected to each other through the third via 323. Conversely, in the present modification, the second lead-out portion 332 and the second dummy lead-out portion 432 may be connected to each other through the second metal layer 620. Accordingly, in the present modification, the third via 323 may be omitted.

The second metal layer 620 may serve to connect the second lead-out portion 332 and the second dummy lead-out portion 432 to each other, and may serve to improve a contact force of the external electrode 520. Specifically, the second metal layer 620 may expand the second lead-out portion 332 to expand a contact area with the external electrode 520.

The second metal layer 620 may include at least one of Cu (copper), Pd (palladium), and Cr (chromium), and may be formed using electroplating, but the present disclosure is not limited thereto.

With respect to the other elements according to the present example embodiment, the description of the first example embodiment of the present disclosure may be applied in the same manner. The detailed description thereof is repeated, and thus omitted below.

While example embodiments have been shown and described above, it will be apparent to those skilled in the art that modifications and variations could be made without departing from the scope of the present disclosure as defined by the appended claims.

What is claimed is:

1. A coil component comprising:
a body having a first surface, a second surface opposing the first surface in a first direction, and a plurality of side surfaces connecting the first surface and the second surface to each other, the plurality of side surfaces including a first side surface and a second side surface opposing each other in a second direction;
a support member disposed in the body;
a coil disposed on each of a first surface of the support member and a second surface of the support member opposing the first surface of the support member in the first direction, the coil including first and second lead-out portions respectively extending to the first side surface and the second side surface; and
a first dummy lead-out portion disposed on the second surface of the support member and connected to the first lead-out portion,
wherein, when a width of the first lead-out portion is W1 and a width of the first dummy lead-out portion is W2, W2/W1 satisfies 0.3 or more and 0.8 or less.

2. The coil component of claim 1, wherein the first dummy lead-out portion extends to the first side surface of the body.

3. The coil component of claim 1, wherein the coil further includes a first coil pattern disposed on the first surface of the support member and connected to the first lead-out portion, a second coil pattern disposed on the second surface of the support member and connected to the second lead-out portion, and a first via passing through the support member and connecting the first and second coil patterns to each other.

4. The coil component of claim 3, wherein the first dummy lead-out portion is spaced apart from the second coil pattern.

5. The coil component of claim 1, wherein
the width of the first lead-out portion represents an average length of the first lead-out portion in the second direction, and
the width of the first dummy lead-out portion represents an average length of the first dummy lead-out portion in the second direction.

6. The coil component of claim 1, wherein the coil further includes a second via passing through the support member and connecting the first lead-out portion and the first dummy lead-out portion to each other.

7. The coil component of claim 1, further comprising:
a first metal layer disposed on the first side surface of the body,
wherein the first metal layer is in contact with the first lead-out portion and the first dummy lead-out portion.

8. The coil component of claim 1, further comprising:
a first external electrode disposed on the first side surface of the body and connected to the first lead-out portion; and
a second external electrode disposed on the second side surface of the body and connected to the second lead-out portion.

9. The coil component of claim 4, wherein the first dummy lead-out portion is the only dummy lead-out portion comprised in the coil component.

10. The coil component of claim 9, further comprising:
a first metal layer disposed on the first side surface of the body, wherein the first metal layer is in contact with the first lead-out portion and the first dummy lead-out portion;
a first external electrode disposed on the first side surface of the body and connected to the first lead-out portion; and
a second external electrode disposed on the second side surface of the body and connected to the second lead-out portion,
wherein the coil further includes a second via passing through the support member and connecting the first lead-out portion and the first dummy lead-out portion to each other.

11. A coil component comprising:
a body having a first surface, a second surface opposing the first surface in a first direction, and a plurality of side surfaces connecting the first surface and the second surface to each other, the plurality of side surfaces including a first side surface and a second side surface opposing each other in a second direction;
a support member disposed in the body;
a coil disposed on each of a first surface of the support member and a second surface of the support member opposing the first surface of the support member in the first direction, the coil including first and second lead-out portions respectively extending to the first side surface and the second side surface;
a first dummy lead-out portion disposed on the second surface of the support member and connected to the first lead-out portion; and
a second dummy lead-out portion disposed on the first surface of the support member and connected to the second lead-out portion,
wherein, when a width of each of the first and second lead-out portions is W1 and a width of each of the first and second dummy lead-out portions is W2, W2/W1 satisfies 0.2 or more and 0.5 or less.

12. The coil component of claim 11, wherein the first and second dummy lead-out portions respectively extend to the first side surface and the second side surface of the body.

13. The coil component of claim 11, wherein the coil further includes a first coil pattern disposed on the first surface of the support member and connected to the first lead-out portion, a second coil pattern disposed on the second surface of the support member and connected to the second lead-out portion, and a first via passing through the support member and connecting the first and second coil patterns to each other.

14. The coil component of claim 13, wherein
the first dummy lead-out portion is spaced apart from the second coil pattern, and
the second dummy lead-out portion is spaced apart from the first coil pattern.

15. The coil component of claim 11, wherein
the width of each of the first and second lead-out portions represents an average length of each of the first and second lead-out portions in the second direction, and
the width of each of the first and second dummy lead-out portions represents an average length of each of the first and second dummy lead-out portions in the second direction.

16. The coil component of claim 11, wherein the coil further includes a second via passing through the support member and connecting the first lead-out portion and the first dummy lead-out portion to each other, and a third via passing through the support member and connecting the second lead-out portion and the second dummy lead-out portion to each other.

17. The coil component of claim 11, further comprising:
first and second metal layers respectively disposed on the first and second side surfaces of the body,
wherein the first metal layer is in contact with the first lead-out portion and the first dummy lead-out portion, and
the second metal layer is in contact with the second lead-out portion and the second dummy lead-out portion.

18. The coil component of claim 11, further comprising:
a first external electrode disposed on the first side surface of the body and connected to the first lead-out portion; and
a second external electrode disposed on the second side surface of the body and connected to the second lead-out portion.

19. The coil component of claim 14, further comprising:
an insulating film on surfaces of the coil, the first dummy lead-out portion, and the second first dummy lead-out portion.

20. The coil component of claim 19, further comprising:
a first external electrode disposed on the first side surface of the body and connected to the first lead-out portion;
a second external electrode disposed on the second side surface of the body and connected to the second lead-out portion; and
first and second metal layers respectively disposed on the first and second side surfaces of the body,
wherein the first metal layer contacts and connects the first lead-out portion and the first dummy lead-out portion,
the second metal layer contacts and connects the second lead-out portion and the second dummy lead-out portion, and
the support member does not include a via that passes through and connect the first lead-out portion and the first dummy lead-out portion to each other.
